(19) United States
(12) Patent Application Publication
(10) Pub. No.: US 2015/0339195 A1
(43) Pub. Date: Nov. 26, 2015

(54) METHOD AND SYSTEM FOR SECURE SYSTEM RECOVERY

(71) Applicant: SanDisk Technologies Inc., Plano, TX (US)

(72) Inventors: Niles Yang, Mountain View, CA (US); Gautham Reddy, San Jose, CA (US); Rohit Sehgal, Santa Clara, CA (US)

(73) Assignee: SanDisk Technologies Inc., Plano, TX (US)

(21) Appl. No.: 14/286,345

(22) Filed: May 23, 2014

(51) Int. Cl. G06F 11/14

(52) U.S. Cl. CPC G06F 11/1441

(57) ABSTRACT

Apparatus and methods implemented therein are disclosed for recovery of information stored in non-volatile memory of embedded and external solid-state memory devices. The apparatus comprises a memory system. The memory system has a non-volatile memory and a memory controller. The memory controller is coupled to the non-volatile memory. The memory controller is also coupled to a memory interface. The memory controller searches the non-volatile memory to locate initialization information required to initialize the memory controller. The memory controller, in response to failing to successfully locate or execute the initialization information, is configured to transmit an indication via the memory interface.

### TECHNICAL FIELD

This application relates generally to mitigating corruption of data in a memory system. More specifically, this application relates to the operation of a memory system that retrieves copies of program code and data in response to detecting corruption of program code and data in the memory system.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Consumers are increasingly replacing their single function devices like cell phones with multi-function devices like smart phones, tablet computers and multi-media players. Consumers demand that their multi-function devices perform increasingly complex tasks. In response to this demand, the market place has produced a wide range of applications. Consumers download these applications from online stores. It is commonplace to find multi-function devices with hundreds of applications and games. Admittedly, storing these applications require memory.

Memory manufacturers have responded by designing solid state drives with large memory storage capacities. It is commonplace to find multi-function devices with 32, 64 and 128 Gigabits of memory. To manage the memory, solid state drive is equipped with a controller that includes its own processor, boot up firmware and software. The processor executes the software to configure the solid state drive. Device manufacturers frequently embed the solid state drives in the device. Thus, if the solid state drive malfunctions removing the drive is difficult, if not impossible. It is not uncommon for a solid state drive to malfunction owing to corruption of the software and boot up data stored in the memory of the solid state drive. It is also not uncommon for the memory resident in a solid state drive to deteriorate with use, time and temperature. Deterioration of memory causes corruption of data stored in portions of the memory. The lost data may include boot up firmware, software and configuration information that the processor of the solid state drive requires to operate the solid state drive. Recovering the lost data while the solid state drive is in situ presents numerous challenges. Methods and apparatus discussed herein address these issues and challenges.

### SUMMARY

In order to address the need for improved reliability in an embedded flash memory device, methods, apparatuses and systems are disclosed herein for recovering from failures of the embedded flash memory device.

According to one aspect, a method is disclosed for initializing a memory system. In one embodiment, the memory system comprises a memory controller and a non-volatile memory. The memory controller, in response to detecting power-up of the memory system, searches the non-volatile memory to locate initialization information. The initialization information includes information to initialize the memory system. The memory controller, upon failing to successfully locate or execute the initialization information, transmits to a host system, a request for initialization information. The memory controller receives data from the host system in response to transmitting the request. The received data includes the initialization information. The memory controller updates the non-volatile memory with the initialization information.

According to another aspect, a method is disclosed for initializing a device. In one embodiment, the device comprises a host system, a memory controller and a non-volatile memory. The host system and the memory controller are communicatively coupled by a memory interface. The host system, in response to causing a reset of the memory controller, receives an indication from the memory controller. The indication corresponds to a failure by the memory controller to detect initialization information in the non-volatile memory. The host system in response to receiving the indication, receiving by the host system data corresponding to the initialization information. The host system transmits the data to the memory controller via the memory interface.

According to another aspect, an apparatus comprising a memory system is disclosed. The memory system has a non-volatile memory and a memory controller. The memory controller is coupled to the non-volatile memory. The memory controller is also coupled to a memory interface. The memory controller is configured to search the non-volatile memory to locate initialization information required to initialize the memory controller. The memory controller, in response to failing to successfully locate or execute the initialization information, is configured to transmit an indication via the memory interface.

Other features and advantages will become apparent upon review of the following drawings, detailed description and claims. Additionally, other embodiments are disclosed, and each of the embodiments can be used alone or together in combination. The embodiments will now be described with reference to the attached drawings.

### BRIEF DESCRIPTION OF THE DRAWINGS

FIG.1 is a block diagram of an example system in which devices may operate to store and retrieve program code and data at a remote storage.

FIG. 2 is an example block diagram of an example device that may operate in the system of FIG.1.

FIG. 3 is an example memory map for flash memory of the example device of FIG. 2.

FIG. 4 is a flow diagram of an example method that may be implemented in a device depicted in FIG. 2.

FIG. 5 is a flow diagram of another example method that may be implemented in a device depicted in FIG. 2.

### DETAILED DESCRIPTION

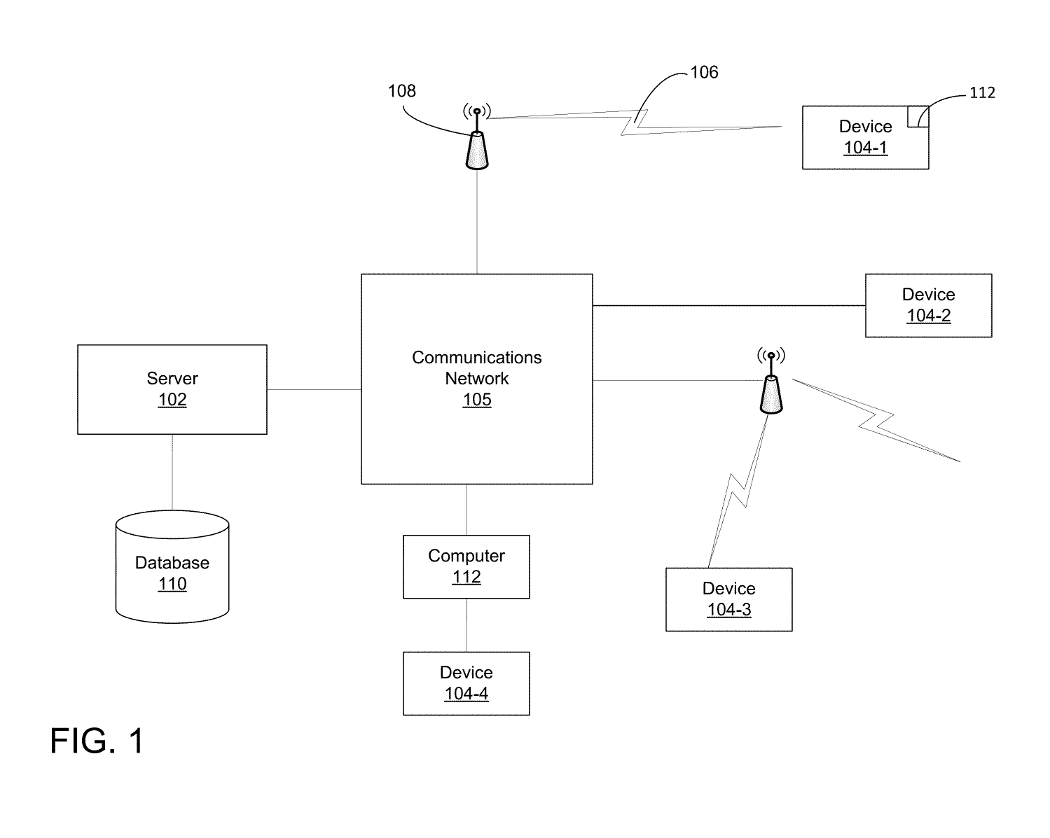

Methods and apparatuses described herein may be implemented in the example system 100 depicted in FIG. 1. By way of example and without limitation, system 100 comprises a server 102 and devices 104-1 to 104-4. Devices 104-1 to 104-4 are communicatively coupled to server 102 via a communications network 105. Each of devices 104-1 to 104-4 may correspond to a device such as a cell phone, a tablet, a solid state device based portable media player, etc. Devices 104-1 to 104-4 may establish a communication channel with server 102. In an exemplary embodiment, device 104-1 may establish a wireless connection 106 with a wireless access point 108 using an appropriate wireless radio-frequency (RF) protocol. Examples of wireless RF protocols include long range protocols like LTE or WiMax, medium range protocols like 802.11 or WIFI and short range protocols like 802.15 or BLUETOOTH. The wireless access point 108 may in turn be connected to the communications network 105. In the implementation where device 104-1 establishes a wireless connection 106 in compliance with the WIFI protocol, wireless infrastructure component 108 may correspond to a WiFi access point.

The wireless connection 106 and the communication link from wireless access point 108 may be collectively referred to as the communication channel between device 104-1 and server 102. One skilled in the art will recognize that the communication channel comprises a physical link and a logical link. A logical link may be established between the device 104-1 and server 102 by utilizing an appropriate connection-oriented TCP/IP protocol. In the example system 100, device 104-2 is coupled to communications network 105 using an appropriate wired communication protocol such as 802.3 or ETHERNET.

During normal operation, device 104-1 may periodically transmit locally stored data and program code to server 102 via communications network 105. In one embodiment, device 104-1 may periodically update data in response to performing maintenance operations. In this embodiment, device 104-1 may transmit to server 102 changes made to the data. Program code corresponds to software instructions that may be executed by a processor (not shown) of device 104-1 during operation. Examples of program code include boot up code or firmware, operating system code, drivers, application code etc. In an embodiment, data may also include configuration parameters for the other hardware components of device 104-1 in addition to configuration parameters for the memory. Server 102 may store the data and program code in database 110. The operation of periodically storing data or program code may be referred to as “backing-up.” In one implementation, during power-up, device 104-1 may detect a hardware or software failure in the device 104-1. By way of example and without limitation, software failures include one or more of corruption of data, corruption of program code, etc. In response to device 104-1 detecting such a failure, it may establish a wireless connection 106 and transmit a request to server 102 for a copy of previously stored uncorrupted program code from server 102, in an exemplary embodiment. In response to receiving a request for program code via communications network 105 from device 104-1, server 102 may retrieve a copy of the previously stored or backed-up uncorrupted program code for device 104-1 from database 110 and transmit the program code to device 104-1. Device 104-1 may receive the program code and update or overwrite the corrupted program code with the received program code. In this manner a device with corrupt program code or data may repair or heal itself. Devices 104-2 to 104-4 may similarly instruct server 102 to store copies of program code or data in database 110. Devices 104-2 to 104-4 may retrieve copies of backed-up program code or data from server 102 in response to detecting corruption of locally stored program code or data.

The backing-up and retrieval of program code or data may occur over a secure connection between server 102 and device 104-1. For example, program code and data may be encrypted prior to being transmitted by server 102, for example. The receiving device 104-1 may decrypt the received program code and data. In one implementation, retrieval of program code and/or data from the server 102 may be performed by using a secure protocol such as secure file transfer protocol (FTPS). A combination of server and device initiated backup process is also contemplated, where different programs backed-up in response to a command from only one or either the server or the device.

In one implementation, device 104-4 may be communicatively coupled to computer 112 using a protocol such as the universal serial bus (USB) protocol. Computer 112 in turn may be connected to the communications network 105 via a wired protocol like ETHERNET or a wireless protocol like WiFi. In one embodiment, in response to a request from device 104-4 for program code and data, computer 112 may retrieve the program code and data from server 102 and transmit the same to device 104-4.

In another implementation, server 102 may instruct device 104-1 to initiate the back-up process. In another implementation, server 102 may transmit or “push” a copy of program code or data to device 104-1 to cause device 104-1 to update its local copy of program code or data stored on device 104-1.

In another exemplary embodiment, the device 104-1 may periodically back-up program code or data to local removable non-volatile storage memory 112. Examples of non-volatile storage memory 112 include memory such as a micro SD device. In this embodiment, in response to detecting a failure or corruption, the device 104-1 may retrieve a copy of the previously backed program code or data from local removable non-volatile storage memory 112.

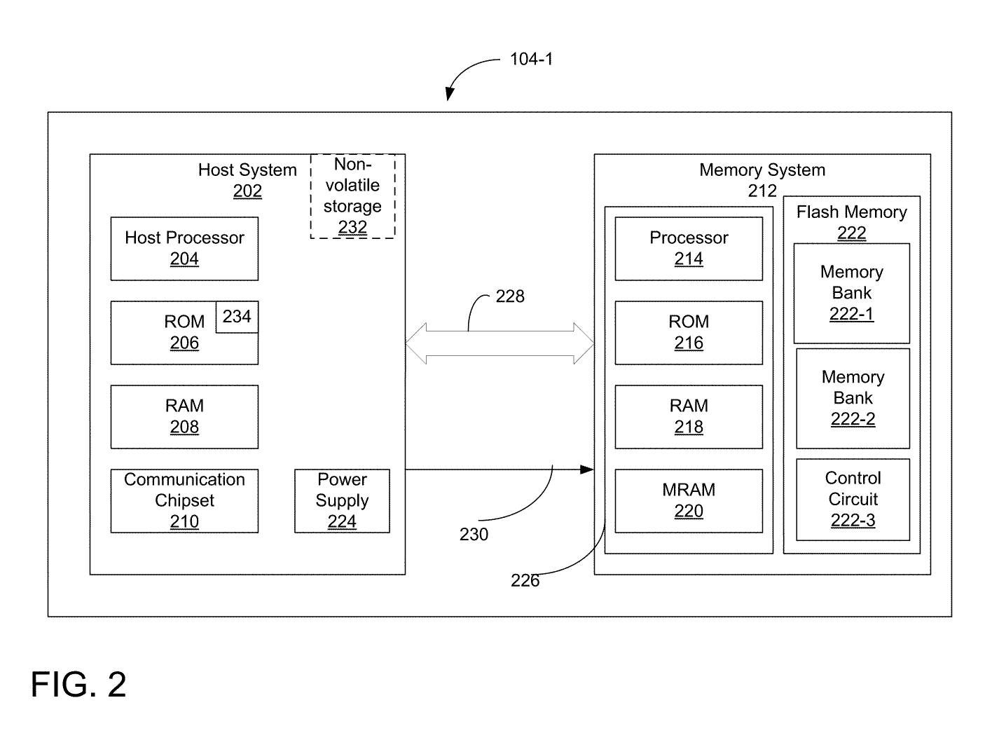

An example block diagram of device 104-1 suitable for use in implementing aspects of the invention is shown in FIG. 2. The device 104-1 comprises a host system 202 and memory system 212. A host system 202 of FIG. 2 stores program code and data, into and retrieves program code and data from, memory system 212. In an exemplary embodiment, the memory system 212 may be embedded within the device 104-1, such as in the form of an integrated flash memory system installed in a smart phone, tablet or media player. Alternatively, the memory system 212 may be in the form of a card that is removably connected to the device 104-1 through mating parts consisting of a mechanical and electrical connector (not shown) conforming to an appropriate standard such as PCMCIA, CompactFlash or other known connector formats. In another embodiment, memory system 212 may be in the form of a discrete module that are drop-in replacements for rotating magnetic disk drives such as a solid state disk (SSD).

The host system 202 comprises a host processor 204, read only memory (ROM) 206, random access memory (RAM), communication chipset 210 and power supply 224. Host processor 204 may execute software driver 234 stored in ROM 206 to configure communication chipset 210. Communication chipset 210 may comprise a WiFi chipset. Host processor 204 may utilize the software driver 234 to cause the communication chipset 210 to establish a wireless connection 106 (FIG. 1) with wireless access point 108. As discussed with respect to FIG. 1, device 104-1 may receive information stored in, or transmit backed-up information to, database 110 via the communications network 105 and wireless connection 106.

The memory system 212 may include flash memory 222, and a memory controller 226, in an embodiment. Flash memory is an electronic non-volatile computer storage medium that can be electrically erased and reprogrammed. In other embodiments, memory system 212 may include other types of volatile or non-volatile memory or any combination thereof. Flash memory 222 may correspond to NAND flash memory. Memory controller 226 interfaces with the host system 202 via memory interface 228. The memory interface 228 may comprise a set of registers that is mapped into the memory or input/output (I/O) space of host system 202. The memory interface 228 may comply with the e-MMC interface, for example. Memory controller 226 operates to communicate data and program code back and forth between host system 202 and flash memory 222. The memory controller 226 may convert between logical addresses of data used by the host system 202 and physical addresses of the flash memory 222 during programming and reading of data. Memory controller 226 may store configuration parameters, boot code and program code in flash memory 222. The flash memory 222 may include any number of memory banks. By way of example and without limitation the term memory bank is used to describe 222-1 and 222-2. However, 222-1 and 222-2 may also correspond to flash dies in the same package.

By way of reference, flash memory banks 222-1 and 222-2 may include a plurality of memory clusters or pages. Each memory cluster may be made up of single-level cell (SLC) or multi-level cell (MLC). SLC flash memory can store a single bit of information per cell. MLC flash memory can store multiple bits of information per cell. For example, two-level MLC flash memory can store 4 bits of information per cell, three-level MLC flash memory can store 8 bits of information per cell and N-level MLC flash memory can store 2^{N} bits of information per cell. Typical sizes of memory clusters are 512 bytes. Memory clusters may be grouped to create physical memory blocks. For example, 4 memory clusters of 2 level MLC flash memory may be grouped to create a 4 Kilobytes memory block or 128 memory clusters of SLC flash memory may be grouped to create a 64 Kilobytes memory block. Generally, erasing a memory cluster requires erasing the entire memory block that the memory cluster belongs to. In some embodiments, a memory bank may consist of memory blocks having different sizes.

In this embodiment, flash memory 222 also includes control circuit 222-3. Memory controller 226 may operate the control circuits 222-3 to read data from, or write data to one or more pages in response to requests from the host system and to erase one or more memory blocks. Control circuits 222-3 may include analog to digital convertors (ADC) and digital to analog convertors (DAC). Memory controller 226 may utilize configuration information stored in to flash memory 222 to operate the control circuits. In this example, configuration information may include voltage levels used to program the DACs to cause writing or erasing cells, etc.

The memory controller 226 may be implemented on a single integrated circuit chip, such as an application specific integrated circuit (ASIC) or may be implemented as several discrete components or any combination thereof. In one embodiment, the memory controller 226 comprises processor 214, ROM 216, RAM 218 and MRAM 220. ROM 216 may be used to store instructions that trace the boot code on the flash memory 222. These instructions when executed by processor 214 cause the initialization and testing of the memory system 212 components and cause the processor to load a boot code or an operating system stored in flash memory 222. In an exemplary embodiment the BIOS stored in ROM 216 may include software instructions for a TCP/IP network stack including suitable file transfer protocol like FTP, TFTP, FTPS, HTTP and HTTPS. TCP/IP, short for Transmission Control Protocol/Internet Protocol, is a group of communications protocols used by devices such as 104-1 to connect to server 102, for example, via a communications network 105. In an exemplary embodiment, device 104-1 may cause communication chipset 210 to establish a communication channel to the communications network 105. In this embodiment, device 104-1 may connect to server 102 via the communication channel established with communications network 105.

Generally, boot code is program code that is stored in flash memory 222 that is located by executing code stored in ROM 216. When located, the boot code is copied to RAM 218 from flash memory 222. Boot code may also include instructions that when executed by processor 214 cause initialization of hardware components of the memory system 212. On successful loading of the boot code the memory system 212 is available to receive commands from the host system 202 to read and write information to flash memory 222.

In normal operation, when device 104-1 is powered on, host system 202 may assert reset line 230 to command the memory system 212 to reset or start operation. In response to receiving a command to reset, processor 214 may start executing instructions corresponding to the BIOS stored in ROM 216. After initialization of the memory system 212, the processor 214 may execute boot code stored in a predetermined block of flash memory bank 222-1 or 222-2 of flash memory 222. Alternatively, the processor 214 may execute instructions of the BIOS to search for boot code and configuration parameters. By way of example and without limitation, boot code and configuration parameters constitute a non-exclusive list of initialization information. Generally, initialization information consists of any information that may be used to configure software and hardware components of the memory system 212.

In another embodiment, when the device is turned on, instructions stored in ROM 216 are executed by processor 214 that cause the memory system to search the boot block location in the flash memory 222 to locate the boot up firmware. Once boot up firmware is located, it is copied to the RAM 218 and the control is transferred to the boot up firmware. Processor 214 may execute instructions during initialization of the device to configure the system parameters. This is done with the help of firmware loaded in to the RAM 218. Once this is done the memory system is ready to receive read and write instructions from the host 202.

Searching for boot code may include searching for a predefined signature in the flash memory bank 222-1. The search may be performed in certain predefined memory blocks of flash memory 222 reserved for storing boot code. Memory blocks reserved for storing boot code and configuration parameters may be referred to as boot blocks. In an exemplary embodiment, a failure to locate a boot-loader may cause the memory system 212 to receive a previously store copy of the boot loader from the database 110 via wireless connection 106. In another embodiment, memory system 212 may retrieve a previously store copy of boot code and configuration parameters from non-volatile memory card 232. Memory system 212 may store the received boot code in the flash memory 222 in the appropriate boot block.

In an exemplary embodiment, memory system 212, in response to failing to detect boot code or configuration parameters, may transmit an indication to host system 202. Memory system 212 may transmit the indication to the host system 202 over the memory interface 228. The indication may instruct the host system 102 to establish a connection with communications network 105. For example, in response to failing to detect the boot code and/or configuration parameters host system 202 may initialize a software driver 234 to control the communication chipset 210. As previously discussed, the communication chipset 210 may be a WiFi chipset, in which case, host system 202 may utilize the software driver 234 to cause communication chipset to establish wireless connection 106. In an embodiment, host system 202 may transmit an indication to memory system 212 indicating that wireless connection 106 is established and the software driver 234 is available to accept commands.

Memory system 212 may utilize the software driver 234 to transmit data to, and receive data from (exchange data), server 102 via wireless connection 106 and communications network 105. Memory system 212 may utilize the TCP/IP stack in the ROM 216 to facilitate the exchange of data. For example, in response to receiving an indication that the wireless connection is established, memory system 212 may create utilize the TCP/IP stack to create a connection-oriented communication channel with server 102 via wireless connection 106 and communications network 105. In some implementations, memory system 212 may utilize the TCP/IP stack to create a secure connection between device 104-1 and server 102 to hinder unauthorized interception of the exchanged data by a third party device. Transmitted data may include requests for boot code or configuration parameters to server 102. Data received from server 102 may include copies of previously stored boot code and or configuration parameters. Memory system 212 may receive the boot code and configuration parameters into RAM 218 and copy the boot code and configuration parameters to newly allocated boot blocks of flash memory 222.

In another embodiment, in response to receiving the indication from memory system 212 of a failure to locate boot code or configuration parameters, host system 202 may establish the wireless connection 106 by utilizing the software driver 234 and communication chipset 210, as previously explained. In addition, host system 202 may utilize a TCP/IP stack stored in ROM 206, for example, to establish a communication channel with server 102. In this embodiment, host system 202 may receive boot code and configuration parameters from server 102. Host system 202 may transmit the received boot code and configuration parameters to memory system 212 via memory interface 228. Memory controller 226 may receive the boot code and configuration parameters and store the same in flash memory 222. In another embodiment, host system 202 may store the received boot code and configuration parameters in non-volatile memory card 232.

In an embodiment, memory system 212 may retrieve the identity information of server 102 from ROM 216. Memory system 212 may communicate the identity information of the server 102 to the host system 202. Identity information includes for example the IP address of server 102. Host system 202 may utilize the identity information to establish the communication channel with server 102. In another embodiment, the host system 202 may store the identity information for server 102 in ROM 206. In this embodiment, in response to receiving the indication from memory system 212 of a failure to locate boot code or configuration parameters, host system 202 may retrieve the identity information for server 102 from ROM 206.

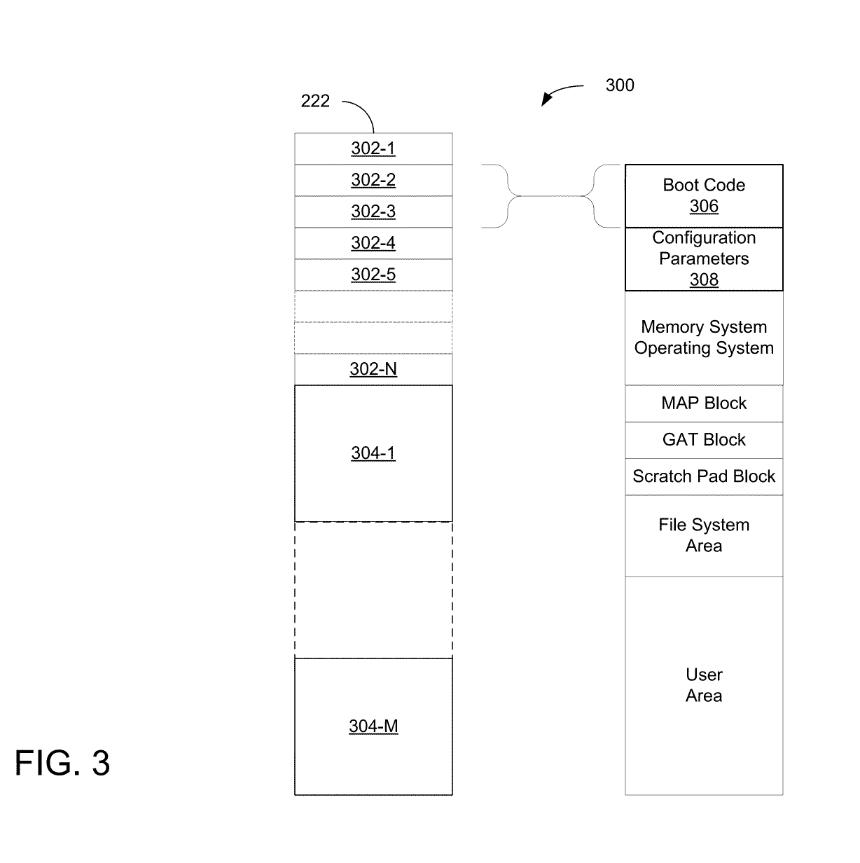

FIG. 3 is an example memory layout 300 of the several previously discussed software elements including boot code 306, configuration parameters 308, memory system operating system 310, etc. The above listed software elements are stored flash memory 222. By way of example and without limitation, boot code 306 occupies memory blocks 302-2 and 302-3 and configuration parameters are stored in memory blocks 302-4 and 302-5. In this example, flash memory 222 consists of memory blocks 302-1, 302-2 . . . 302-N, 304-1 . . . . 304-M. By way of example and without limitation, flash memory 222 consists on N memory blocks having a first size or storage capacity and M memory blocks having a second storage capacity. The N memory blocks may correspond to boot blocks where boot code 306 and configuration parameters 308 are stored. Configuration parameters may include information about the geometry of the memory flash 222 i.e. the number M and N, the arrangement and ordering of the memory blocks, the density of the memory blocks i.e. number of levels in an MLC, the voltage levels to be applied to a cell to erase or write a bit to the cell, etc. Memory blocks 304-1 . . . 304-M may be used by host system 202 to store the host operating system, IOS for example, and user applications.

As previously discussed, in response to a power-on reset of the device 104-1, the host system 202 may initiate communication with memory system 212. In response, the processor 214 may retrieve and execute instructions corresponding to BIOS stored in ROM 216. After successful initialization of the various components of the memory system 212, the processor 214 may execute instructions in ROM 216 to search for boot code in memory blocks. The instructions stored in ROM 216 that search for boot code may be referred to as a boot loader. The boot loader may search the boot blocks 302-1 to 302-N of flash memory 222 for a signature that indicates that a valid copy of boot code is located in the boot blocks.

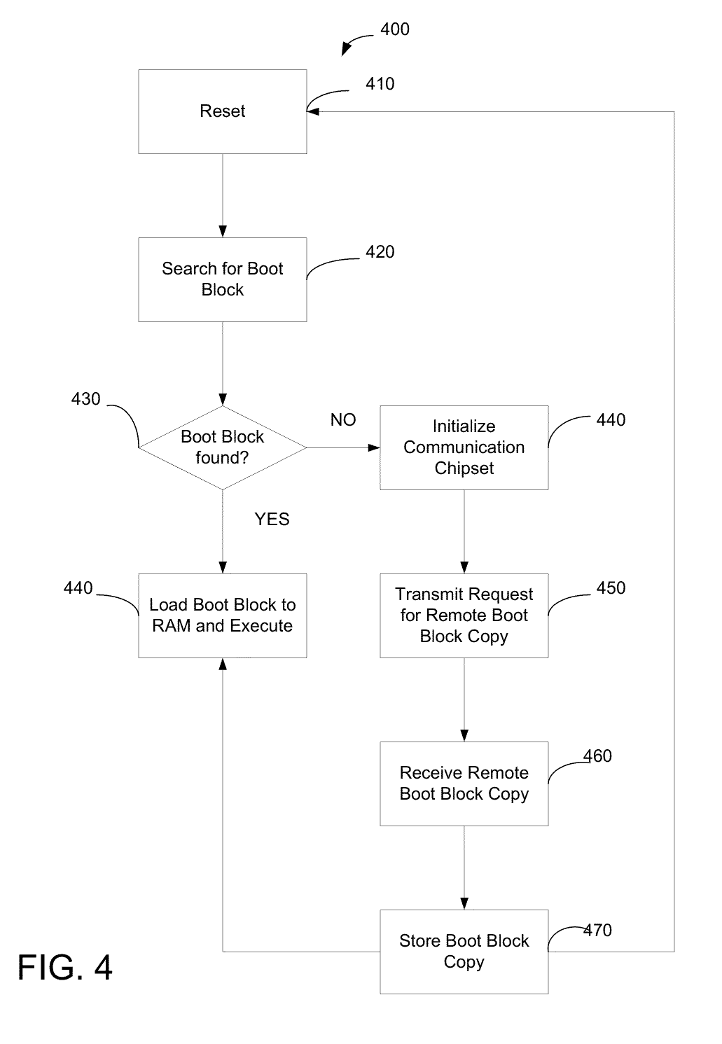

FIG. 4 is a flow diagram of an example method 400 that may be implemented in device 104-1, for example, to facilitate the retrieval of boot code and configuration parameters, in an embodiment. In this embodiment, the retrieval of boot code and configuration parameters may be in response to the memory system 212 detecting a corruption of boot code or configuration parameters stored in flash memory 222. Functionality ascribed to each of the steps of method 400 may be implemented in memory system 212 or host system 202. In some embodiments, part of the functionality performed at a step may be performed by memory system 212 and other parts of the functionality performed at the step may be performed by host system 202.

At step 410, host system 202 and memory system 212 may be reset. The reset may be in response to a power-on-reset of device 104-1. In an embodiment, at step 410, memory system 212 may receive a reset signal from host system 202. The reset signal may be communicated via reset line 230, in an embodiment. In another embodiment, at step 410, memory system 212 may receive a command to reset via memory interface 228. In response to the reset, host system 202 and memory system may initialize each of their respective components. For example, processor 214 may retrieve and execute instructions stored in ROM 216.

At step 420, memory system 212 may search flash memory 222 to locate boot code. With reference to FIG. 3, processor 214 may search flash memory 222 by executing instructions stored in ROM 216 that cause processor to examine the contents of boot block 302-1 . . . 302-N. By way of example and without limitation, the first “N” bytes of a boot block may be examined to locate a signature string or a header that conforms to a predefined format. The first “N” bytes of data of a boot block 302-1 may be compared with a predefined signature string at block 420. In the implementation where the boot code is encapsulated with a predefined header, at step 420, processor 214 may validate the integrity of the header by performing for example a checksum over the header. One skilled in the art will recognize that the header may include information regarding the boot code including for example an offset to the start of the boot code, the size (length) of the boot code, a checksum of the boot code, boot code entry point etc. In another embodiment, the integrity of the boot code associated with the header may be verified at step 420 by utilizing information regarding the boot code stored in the header.

At step 430, if the data read at step 420 includes the predefined signature and if the validity of any header is confirmed, memory system 212 may conclude that the contents of the boot block, 302-1 for example, include boot code. If for example, the predefined signature is located but the integrity of the header and/or the boot code cannot be verified (checksum failure), the boot code may not be capable of being executed by processor 214. In a typical implementation, one or more SLC or MLC used to store one or more bits of information of the boot code or configuration parameters may get corrupted causing the failure of the integrity of the boot code.

At step 440, if the validity of the boot code is verified, the contents of the boot block may be copied to RAM 218 and executed by processor 214. At step 440, configuration parameters stored in the boot block may be retrieved. As previously explained, the configuration parameters may be used to configure voltages used to read, write and erase data stored in flash memory 222. Executing the instructions from RAM may cause the boot code to search for and locate memory system operating system 310 (FIG. 3). After successful initialization of operating system 310, memory system 212 may inform host system 202 that memory system 212 is available to read and write data to flash memory 222.

Step 440 may be executed in response to failing to detect a valid boot code in boot block 301-1 to 302-N (FIG. 3) or failing to validate the integrity of the boot code. In an embodiment, memory system 212 may communicate the failure to detect valid boot code to host system 202. In response, host system 202 may initialize communication chipset 210. In one implementation, at step 440, host processor 204 may execute instructions that load an appropriate software driver 234 from ROM 206 into RAM 208. The software driver 234 provides functionality to initialize and control the communication chipset 210. Host processor 204 may execute the software driver 234 to configure the communication chipset 210. Communication chipset 210 may correspond to a WiFi chipset, in an embodiment. In this embodiment, at step 440, the software driver 234 may initialize the WiFi chipset and cause the establishment of wireless connection 106 with wireless access point 108. One skilled in the art will recognize that the wireless connection 106 may conform to the 802.11 specification. In another embodiment, communication chipset 210 may correspond to a cellular chipset. In this embodiment, at step 440, host system 202 may create a cellular connection with wireless access point 108.

In one embodiment, at step 450, host system 202 may inform memory system 212 that communication chipset 210 is initialized and available. The information may be communicated via memory interface 228. The information may include function entry points into the software driver 234. Examples of function entry points include an entry point to cause the transmission of data via the communication chipset 210, an entry point to retrieve any received data etc. At step 450, memory system 212 may initialize an appropriate networking stack. Examples of networking stacks include the TCP/IP stack. As previously discussed, the networking stack may be stored in ROM 216. After initializing the networking stack, processor 214 may execute instructions to programmatically and logically “link” the networking stack with the function entry points, in an embodiment. Processor 214, at step 450, may generate a request for boot code and configuration parameters. The request may be formatted in accordance with a predetermined protocol. In an embodiment, at step 450, a logical connection may be established with server 102 via wireless connection 106 and communications network 105. The logical connection may be established with server 102 using identity information, IP address for example, of server 102. The identity information may be stored and retrieved from ROM 216. One skilled in the art will recognize that the logical connection may be created using the sockets interface of the TCP/IP stack. The logical connection in which case may conform to the transmission control protocol. The request may be transmitted to server 102 via the networking stack, the software driver 234 and the logical connection.

At step 460, memory system 212 may receive a copy of the boot block and configuration parameters that was transmitted by server 102. Depending on the file transfer protocol employed, the boot code may be received as several data packets. At step 460, the various packets may be assembled into a boot code file. The file may be assembled and stored in RAM 218. At step 460, the integrity of the boot code file may be verified, for example, by computing a checksum for the boot code file and comparing it with the checksum included in the boot code file.

At step 470, the boot code file may be stored into the appropriate boot blocks of flash memory 222. For example, referring to FIG. 3, the boot code 306-1 may be stored in boot blocks 302-2 and 302-3. Separately, any received configuration parameters may be stored in a corresponding boot block, 302-1, for example. After storing the boot code, in an embodiment, memory system 212 may perform a self-reset. Alternatively, memory system 212 may inform host system 202 that the boot code has been saved. In response, host system 202 may instruct memory system 212 to reset. In another embodiment, memory system 212 may execute the boot code that was stored in RAM.

Returning to step 450, in another embodiment, at step 450, host system 202 after initializing the communication chipset 210 and establishing the wireless connection 106 may establish the previously discussed logical connection with server 102. In this embodiment, host processor 204 may initialize a TCP/IP networking stack that is stored in ROM 206. In general, the steps performed by memory system 212 at step 450, may instead be performed by the host system 202, in this embodiment.

In another embodiment, at step 450, in response to receiving an indication from memory system 212 that valid boot code was not found in the boot blocks of flash memory 222, host system 202 may check the contents of removable non-volatile storage 232 to determine if a copy of boot code and configuration parameters were previously stored. In response to not detecting a copy of boot code and configuration parameters in removable non-volatile storage 232, host system 202 may transmit a request to server 102 for boot code and configuration parameters.

At step 460, the host system 202 may receive the boot code and configuration parameters and verify the integrity of the received boot code. In an embodiment, host system 202 may store the received boot code and configuration parameters in non-volatile storage 232. Host system 202 may transfer the received boot code and configuration parameters to memory system 212 via memory interface 228. Memory system 212 may receive the boot code and configuration parameters into RAM 218.

At step 470, memory system 212 may store the received boot code and configuration parameters into the appropriate boot blocks of flash memory 222. For example, referring to FIG. 3, the boot code 306-1 may be stored in boot blocks 302-2 and 302-3. Separately, any received configuration parameters may be stored in a corresponding boot block, 302-1, for example. After storing the boot code, in an embodiment, memory system 212 may perform a self-reset. Alternatively, memory system 212 may inform host system 202 that the boot code has been saved. In response, host system 202 may instruct memory system 212 to reset. In another embodiment, memory system 212 may execute the boot code that was stored in RAM.

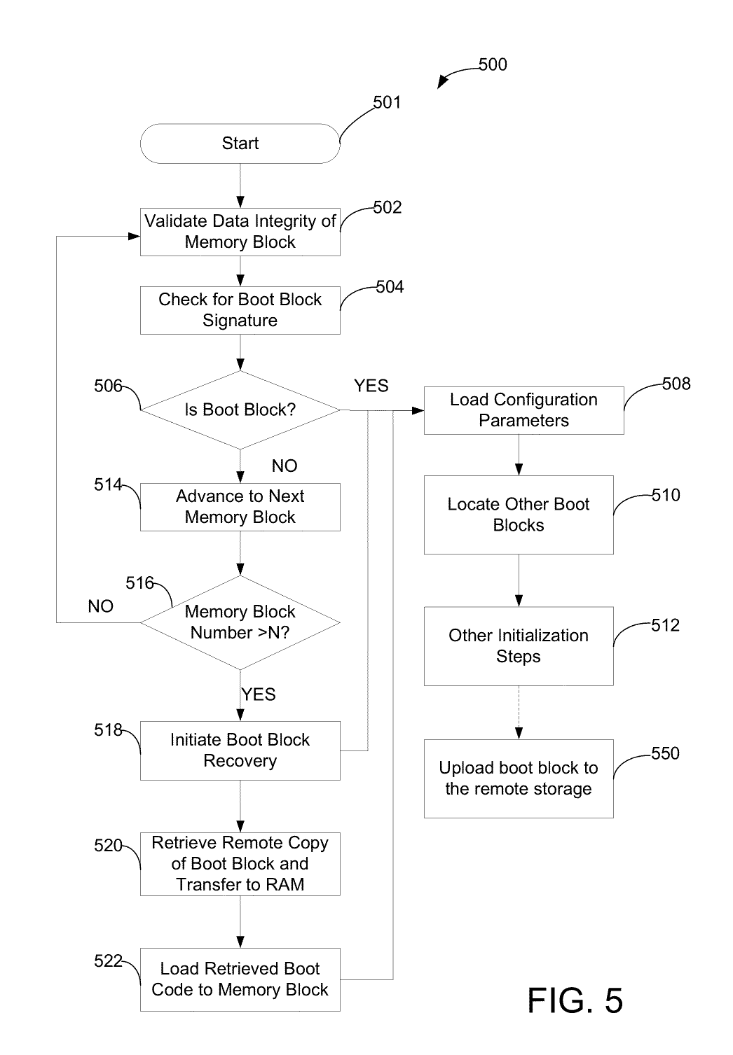

FIG. 5 is another flow diagram of example method 500 that may be implemented in device 104-1, for example, to facilitate the retrieval of boot code and configuration data from server 102 or removable non-volatile memory card, in an embodiment. As previously stated, some functionality ascribed to the blocks of FIG. 5 may be implemented in the host system 102 and other functionality ascribed to the blocks of FIG. 5 may be implemented in the memory system 212.

At step 501, memory system 212 may receive a reset indication via line 230, in an embodiment. In another embodiment, memory system 212 may receive the reset indication via the memory interface 228. At step 501, in response to receiving the reset memory controller 226 may initialize and configure various hardware system and components (not shown) of the memory system 212. Processor 214 may execute instructions stored in ROM 216 to cause the initialization of the various hardware system and components, at step 510. At step 501, processor 214 may execute instructions stored in ROM 216 to search the memory blocks of flash memory 222 to locate boot code and configuration parameters. The set of instructions executed to perform the search may be referred to as the boot loader. In an embodiment, only a subset of the memory blocks may be searched. The subset may correspond to the boot blocks.

At step 502, the data integrity of a memory block may be verified. Verification may include validating the error correcting code (ECC) associated with the memory block. At step 504, the memory block may be searched to locate a signature indicative of the presence of boot code and configuration parameters. In an embodiment, the contents of a predefined location of the memory block may be read. As previously discussed with reference to step 420 of FIG. 4, in some embodiments checking for the boot block signature may include examining the contents of a data structure stored at a predefined location in the memory block. At step 506, in an embodiment, the read contents of the predefined location of the memory block may be compared with the pre-determined signature to determine if valid boot code is stored in the memory block. Examples of a signature include a string such as “$BO#”.

If a boot signature is detected, processor 214 may execute instructions that cause program flow to branch to functionality associated with step 508. At step 508, configuration parameters associated with flash memory 222 may be read from the boot block. As previously discussed, configuration parameters include information that enables the reading, writing and erasing of memory blocks, programming voltage levels for example. Configuration parameters also include the identification of previously identified bad memory blocks, logical to physical mapping tables etc.

At step 510, additional boot blocks may be identified. For example, the boot block identified at step 506 may include references to additional memory blocks that include additional boot code. In an embodiment, at step 510, the boot code from the boot block identified at step 506 may be copied to RAM 218 and executed by processor 214. Executing the boot code may cause the processor to identify and copy additional boot code from boot blocks. This process may be referred to as bootstrapping. After initialization of the memory system 212, the memory system 212 is available to accept commands from the host system 202.

At step 512, memory system 212 may perform additional initialization steps including executing a scheduler of an operating system, updating a file allocation table etc.

At step 550, memory system 212 may execute instructions to generate a copy of boot code and configuration parameters and back up the copy. The instructions at step 550 may be periodically executed, in an embodiment. In another embodiment, the instructions at step 550 may be executed in response to change in conditions, for example, if new bad memory blocks are detected, if temperature exceeds a preconfigured threshold.

In an embodiment, backing-up the copy of boot code and configuration parameters includes for example instructing the host system 202 to save the copy in removable non-volatile memory device 232. In another embodiment, backing-up the copy of boot code and configuration parameters includes for example instructing the host system 202 to transmit the copy to server 102 via wireless connection 106. As previously discussed, changes may be made to data stored in the boot blocks in response to periodic flash memory 222 maintenance operations. A copy of the changes made may be communicated to server 102 by device 104-1. This is done so that the latest copy of boot block code stored in flash memory 222 and the server 102 are kept synchronized.

Returning to step 506, if a valid boot signature is not detected, program flow branches to step 514. At step 514, a pointer or variable may be incremented by a value corresponding to the size of a boot block, in an embodiment. Thus, the pointer may point to the next boot block. Referring to FIG. 3, after the first increment, the pointer may point to boot block 302-2. In some embodiments, the number of times the pointer is incremented may be tracked and compared with the number of boot blocks in flash memory 222, at step 516. If the number is less than the number of boot blocks, program flow may branch to step 502 to repeat the process of locating boot code in the next boot block pointed to by the pointer. The steps between steps 502 to 516 may be repeatedly performed until a valid boot code signature is detected in a boot block.

Step 518 may be executed in response to failing to detect boot in any of the boot block. Referring to FIG. 3, step 518 may be executed in response to failing to detect boot code in boot blocks 302-1 to 302-N. Initiating boot block recovery may include the memory system 212 communicating an indication to host system 202 via memory interface 228. In response, in an embodiment, host system 202 may retrieve a previously stored copy of boot code and configuration data from removable non-volatile storage 232 and communicate the copy to memory system 212. In another embodiment, host system 202 may establish wireless connection 106, as previously described. Host system 202 may transmit a request for boot code from server 102 via wireless connection 106 and communications network 105.

At step 520, boot code and configuration parameters previously stored at database 110 may be received by host system 102. The boot code and configuration parameters may be retrieved from database 110 by server 102 and transmitted to host system 102. The validity of the received boot code may be verified at step 520, in an embodiment. The received boot code may be communicated to memory system 212 via memory interface 226 by host system 202. At step 522, memory system 212 may store the received boot code in appropriate memory blocks. Blocks 508, 510 and 512 may then be sequentially executed as previously detailed.

Devices 104-1 to 104-4 include semiconductor memory devices. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device level. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

We claim:

1. A method for initializing a memory system, the memory system comprising a memory controller and a non-volatile memory, the method comprising:
in response to detecting power-up of the memory system, the memory controller searching the non-volatile memory to locate initialization information, wherein the initialization information includes information to initialize the memory system;
upon failing to successfully locate or execute the initialization information, transmitting by the memory controller to a host system a request for the initialization information; and
in response to transmitting the request, receiving by the memory controller data from the host system, wherein the received data includes the initialization information; and
updating by the memory controller the non-volatile memory with the initialization information.

2. The method of claim 1, wherein the non-volatile memory comprises a set of memory blocks and, wherein searching the non-volatile memory for initialization information comprises determining if one of the set of memory blocks includes a signature indicative of the initialization information.

3. The method of claim 2, wherein transmitting the request for information is in response to the memory controller failing to find the signature in the set of memory blocks.

4. The method of claim 1, wherein the memory controller searches the non-volatile memory for information in response to receiving an indication from the host system.

5. The method of claim 1, wherein the initialization information comprises boot code wherein in response to receiving the boot code the memory controller stores the boot code in random access memory (RAM).

6. The method of claim 5, further comprising executing instructions of the boot code from the RAM wherein execution of the instructions initializes the memory system.

7. The method of claim 6, further comprising transmitting, in response to initializing the memory system, a second indication to the host system.

8. The method of claim 7, further comprising reading information from a set of memory blocks of the non-volatile memory and transmitting the read information to the host system.

9. A method for initializing a device, the device comprising a host system, a memory controller and a non-volatile memory wherein the host system and the memory controller are communicatively coupled by a memory interface, the method comprising:
in response to the host system causing a reset of the memory controller, receiving by the host system an indication from the memory controller, wherein the indication corresponds to a failure by the memory controller to detect initialization information in the non-volatile memory;
in response to receiving the indication, receiving by the host system data corresponding to the initialization information; and
transmitting by the host system via the memory interface data corresponding to the initialization information to the memory controller.

10. The method of claim 9, further comprising establishing by the host system a wireless connection with a server in response to receiving the indication.

11. The method of claim 10, further comprising transmitting via the wireless connection a request for initialization information.

12. The method of claim 11, further comprising in response to transmitting the request receiving by the host system via the wireless connection data corresponding to boot code.

13. The method of claim 12, further comprising storing by the host system the data corresponding to initialization information in a removable non-volatile memory device.

14. The method of 9, further comprising retrieving by the host system data corresponding to initialization information stored in a removable non-volatile memory device.

15. An apparatus comprising:
a memory system, the memory system having
a non-volatile memory; and
a memory controller coupled to the non-volatile memory and a memory interface, wherein the memory controller is configured to search the non-volatile memory to locate initialization information to initialize the memory controller and transmit, in response to failing to detect or execute the initialization information, an indication via the memory interface.

16. The apparatus of claim 15, further comprising a host system communicatively coupled to the memory interface and wherein the host system is communicatively coupled to a removable non-volatile storage device and wherein the host system, in response to receiving the indication, is configured to search the removable non-volatile storage device for data corresponding to the information and in response to locating the data is further configured to communicate the data to the memory controller via the memory interface.

17. The apparatus of claim 16, further comprises a communication chipset wherein the host system is communicatively coupled to the communication chipset and wherein the host system is configured to cause the communication chipset to establish a wireless connection with a communication network.

18. The apparatus of claim 15 wherein the non-volatile memory is a three dimensional memory.
